(19) United States
(12) Patent Application Publication
(10) Pub. No.: US 2026/0211804 A1
(43) Pub. Date: Jul. 23, 2026

(54) ENVIRONMENT CONSTRUCTION MANAGEMENT APPARATUS, SYSTEM, METHOD, AND PROGRAM

(71) Applicant: NEC Corporation, Tokyo (JP)

(72) Inventor: Ryota KUBONIWA, Tokyo (JP)

(73) Assignee: NEC Corporation, Tokyo (JP)

(21) Appl. No.: 19/139,590

(22) PCT Filed: Nov. 28, 2023
(86) PCT No.: PCT/JP2023/042554

§ 371 Date: Jun. 16, 2025

(30) Foreign Application Priority Data
Dec. 27, 2022 (JP) 2022-209128

(51) Int. Cl. G06F 11/3698; G06F 11/3668

(52) U.S. Cl. CPC G06F 11/3698; G06F 11/3684

(57) ABSTRACT

An environment construction management apparatus includes: a detection unit configured to detect a change in an environmental element that could affect an environment construction process of a predetermined information system; a specifying unit configured to specify processing condition information corresponding to an environmental element in which a change is detected; a testing unit configured to perform a test for the environment construction process using the specified processing condition information for a testing environment for the information system; and a registration unit configured to register, as history information, a result of the test and the specified processing condition information in association with each other. In this way, it is possible to support the maintenance of the normal operation of an environment construction process irrespective of changes in factors that could otherwise affect the operation of the environment construction process.

### TECHNICAL FIELD

The present disclosure relates to an environment construction management apparatus, a system, a method, and a program.

### Background Art

In recent years, a method called IaC (Infrastructure as Code) has become widespread as a method for automating the construction of an environment for an information system. An environment construction tool (or an orchestrator) for implementing an IaC executes an environment construction process using program code called IaC code. The IaC code is a script file in which an environment construction process and setting values and the like for each environment are described.

Patent Literature 1 discloses a technology related to the configuration management of a system to be constructed. In Patent Literature 1, a system to be constructed is constructed based on an IaC. Further, the configuration of the system to be constructed is changed when the setting of an apparatus constituting the system to be constructed is changed.

Patent Literature 2 discloses a technology related to the control of a virtual system. In Patent Literature 2, an automatic test is carried out for a designated virtual system.

### CITATION LIST

### Patent Literature

Patent Literature 1: Japanese Unexamined Patent Application Publication No. 2021-140372

Patent Literature 2: Japanese Unexamined Patent Application Publication No. 2010-113381

### SUMMARY OF INVENTION

Note that the execution of an environment construction process in an information system to be operated is affected by various external factors. Therefore, a technology for maintaining the normal operation of an environment construction process for automating the construction of an infrastructure is required.

In view of the problem described above, an object of the present disclosure is to provide an environment construction management apparatus, a system, a method, and a program for supporting the maintenance of the normal operation of an environment construction process irrespective of changes in factors that could otherwise affect the operation of the environment construction process.

An environment construction management apparatus according to the present disclosure includes:
detection means for detecting a change in an environmental element that could affect an environment construction process of a predetermined information system;
specifying means for specifying processing condition information corresponding to an environmental element in which a change is detected;
testing means for performing a test for the environment construction process using the specified processing condition information for a testing environment for the information system; and
registration means for registering, as history information, a result of the test and the specified processing condition information in association with each other.

An environment construction management system according to the present disclosure includes:
an information processing apparatus connected to the storage device, in which
the information processing apparatus includes:
detection means for detecting a change in an environmental element that could affect an environment construction process of a predetermined information system;
specifying means for specifying processing condition information corresponding to an environmental element in which a change is detected;
testing means for performing a test for the environment construction process using the specified processing condition information for a testing environment for the information system; and
registration means for registering, as history information, a result of the test and the specified processing condition information in association with each other in the storage device.

In an environment construction management method according to the present disclosure, a computer:
detects a change in an environmental element that could affect an environment construction process of a predetermined information system;
specifies processing condition information corresponding to an environmental element in which a change is detected;
performs a test for the environment construction process using the specified processing condition information for a testing environment for the information system; and
registers, as history information, a result of the test and the specified processing condition information in association with each other in a storage device.

An environment construction management program according to the present disclosure causes a computer to perform:
detection means for detecting a change in an environmental element that could affect an environment construction process of a predetermined information system;
specifying means for specifying processing condition information corresponding to an environmental element in which a change is detected;
testing means for performing a test for the environment construction process using the specified processing condition information for a testing environment for the information system; and
registration means for registering, as history information, a result of the test and the specified processing condition information in association with each other.

According to the present disclosure, it is possible to provide an environment construction management apparatus, a system, a method, and a program for supporting the maintenance of the normal operation of an environment construction process irrespective of changes in factors that could otherwise affect the operation of the environment construction process.

### BRIEF DESCRIPTION OF DRAWINGS

FIG. 1 is a block diagram showing a configuration of an environment construction management apparatus;

FIG. 2 is a flowchart showing a flow of an environment construction management method;

FIG. 3 is a block diagram showing an overall configuration of an environment construction management system;

FIG. 4 is a block diagram showing a configuration of an environment construction management apparatus;

FIG. 5 shows a structure of a test history DB;

FIG. 6 is a sequence diagram showing a flow of an environment construction management process;

FIG. 7 is a sequence diagram showing the flow of the environment construction management process;

FIG. 8 is a sequence diagram showing the flow of the environment construction management process;

FIG. 9 is a sequence diagram showing the flow of the environment construction management process;

FIG. 10 is a flowchart showing a flow of an environment construction management process;

FIG. 11 shows an example of a test history DB;

FIG. 12 is a block diagram showing an overall configuration of an environment construction management system;

FIG. 13 is a sequence diagram showing a flow of an environment construction management process;

FIG. 14 is a sequence diagram showing the flow of the environment construction management process; and

FIG. 15 is a flowchart showing a flow of an environment construction management process.

### EXAMPLE EMBODIMENT

An example embodiment according to the present disclosure will be described hereinafter in detail with reference to the drawings. The same reference numerals (or symbols) are assigned to the same or corresponding elements throughout the drawings, and redundant descriptions thereof will be omitted as appropriate for clarifying the explanation.

### First Example Embodiment

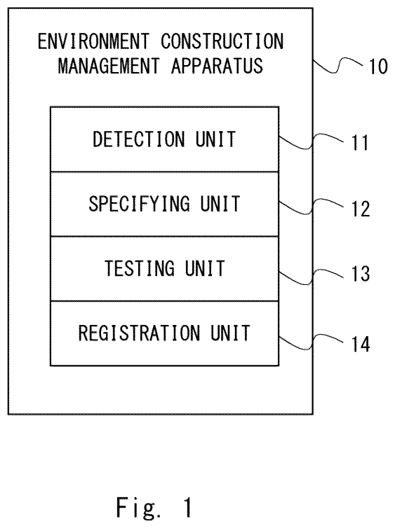

FIG. 1 is a block diagram showing a configuration of an environment construction management apparatus 10. The environment construction management apparatus 10 is an information processing apparatus for managing an environment construction process for a predetermined information system. Note that the environment construction process is a process for automating the construction of the execution environment of an information system by software. The execution environment of an information system includes the configuration of hardware such as a server, a network device, or the like, an OS (Operating System) running on a server or the like, the configuration of software such as middleware, an application, and a driver, and a network configuration. Further, the execution environment of an information system includes an operating environment in which an information system is actually operated, and a testing environment used for the development of an information system, the checking of the operation before an information system is released, and the investigation or the like of a failure during the operation. The execution environment of an information system includes a virtual environment implemented by a virtual system. That is, both or either of the operating environment and the testing environment may include a virtual environment.

Further, the environment construction process may be implemented by executing an environment construction tool by using the IaC code or the like described above. The IaC code, the environment construction tool, or the execution environment (the operating environment or the testing environment) may refer to reference information showing package software (a module group) developed and provided by an outside organization. The IaC code, the environment construction tool, the execution environment, the reference information, or the like is an environmental element that could affect the environment construction process of the information system. The influence on the environment construction process is a change in the execution content or execution result of the environment construction process. Examples of such influences include a situation where the execution of the environment construction process fails and a situation where the environment construction process is not properly operated. However, the influence on the environment construction process is not limited to these examples.

The environment construction management apparatus 10 includes a detection unit 11, a specifying unit 12, a testing unit 13, and a registration unit 14. The detection unit 11 detects a change in an environmental element that could affect the environment construction process of a predetermined information system. The detection unit 11 may detect such a change by monitoring a specific environmental element. Alternatively, the detection unit 11 may detect a change by receiving an update notification of a specific environmental element from a monitoring tool that monitors the specific environmental element. Alternatively, the detection unit 11 may detect a change by receiving an update notification from a specific environmental element.

The specifying unit 12 specifies processing condition information corresponding to the environmental element in which the change has been detected. Note that the processing condition information is information indicating conditions of information used when the environment construction process is executed. For example, the processing condition information is information on the version or the like of an environmental element.

The testing unit 13 performs a test, for the testing environment for the information system, for the environment construction process using the processing condition information specified by the specifying unit 12. That is, the testing unit 13 performs a test for checking the operation of the environment construction process by executing the environment construction process for the testing environment instead of executing it for the operating environment for the information system.

The registration unit 14 associates the result of the test performed by the testing unit 13 with the processing condition information specified by the specifying unit 12, and registers them as history information. The registration unit 14 registers the history information in a storage device (not shown) disposed inside or outside the environment construction management apparatus 10.

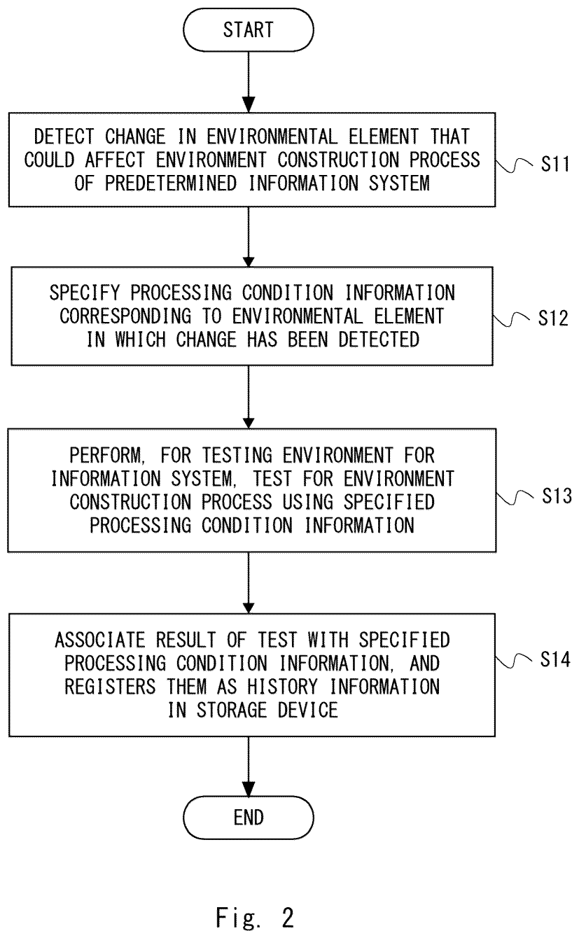

FIG. 2 is a flowchart showing a flow of an environment construction management method. Firstly, the detection unit 11 detects a change in an environmental element that could affect the environment construction process of a predetermined information system (S11). Next, the specifying unit 12 specifies processing condition information corresponding to the environmental element in which the change has been detected (S12). Then, the testing unit 13 performs, for the testing environment for the information system, a test for the environment construction process using the specified processing condition information (S13). After that, the registration unit 14 associates the result of the test with the specified processing condition information, and registers them as history information in the storage device (S14).

As described above, when the environment construction management apparatus 10 according to this example embodiment detects a change in an environmental element that could affect the environment construction process of the predetermined information system, it performs, for the testing environment, a test for the environment construction process using the processing condition information corresponding to the environmental element in which the change has been detected. Then, the environment construction management apparatus 10 associates the result of the execution of the test (hereinafter also referred to as the test execution result) with the processing condition information used in the test, and registers them as history information. That is, the environment construction management apparatus 10 checks the operation of the environment construction process in a successive manner according to changes in external factors that could affect the environment construction process, and accumulate history of the results of the operation checks and the processing condition information of respective environmental elements used in the operation checks. Therefore, a person in charge of the environment construction can recognize a fact that the environment construction process has ceased to properly operate for the testing environment as soon as it has ceased to properly operate, and therefore can take appropriate measures. Therefore, when it becomes necessary to execute the environment construction process of the information system for the operating environment, it becomes possible to properly execute the environment construction process. That is, it is possible to support the maintenance of the normal operation of the environment construction process irrespective of changes in factors that could otherwise affect the operation of the environment construction process.

Note that the environment construction management apparatus 100 includes a processor, a memory, and a storage device as a configuration not shown. Further, in the storage device, a computer program in which the processes of the environment construction management method according to this example embodiment are implemented is stored. Further, the processor loads the computer program and the like from the storage device onto the memory, and executes the loaded computer program. In this way, the processor implements the functions of the detection unit 11, the specifying unit 12, the testing unit 13, and the registration unit 14.

Alternatively, each component of the environment construction management apparatus 100 may be implemented by dedicated hardware. Further, some or all of the components of apparatuses may be implemented by a general-purpose or dedicated circuitry, processor or the like, or a combination thereof. They may be configured by a single chip or by a plurality of chips connected through a bus. Some or all of the components of apparatuses may be implemented by a combination of the above-described circuitry or the like and the program. Further, a CPU (Central Processing Unit), a GPU (Graphics Processing Unit), an FPGA (Field-Programmable Gate Array), a quantum processor (quantum computer control chip) or the like may be used as a processor.

Further, when some or all of the components of the environment construction management apparatus 100 are implemented by a plurality of information processing apparatuses, circuits, or the like, the plurality of information processing apparatuses, circuits, or the like may be disposed at one place in a concentrated manner or distributed over a plurality of places. For example, the information processing apparatuses, circuits, or the like may be implemented in the form of a client-server system, a cloud computing system, or the like in which components or the like are connected to each other through a communication network. Further, the functions of the environment construction management apparatus 100 may be provided in the form of Saas (Software as a Service).

### Second Example Embodiment

A second example embodiment is a specific example of the first example embodiment described above. The problem to be solved by this example embodiment will be explained hereinafter again. Owing to the IaC, which automates the construction of an infrastructure for an information system, it becomes possible to construct the execution environment for an information system at a high speed, at a low cost, and with high repeatability. However, there is a possibility that an IaC that was executable in the previous environment construction becomes inoperable or fails in the execution in the next environment construction. Such a situation can be expressed as the degradation of the IaC or the loss of freshness of the IaC. The reason for such a situation is that an environment construction process using an IaC is affected by various external factors (environmental factors). Examples of external factors include a change in the IaC code itself, a change in an environment construction tool or execution environment (operating environment or the like), and a change in an outside package or the like to which they refer. Examples of changes in operating environments include a change in the OS setting (an update of a configuration file) and an application of a patch.

Therefore, it is difficult to keep the freshness of the IaC. Further, when the IaC deteriorates, there is a possibility that an infrastructure engineer, who created the IaC with a large number of man-hours, has to re-create the IaC. Therefore, the cost increases. Further, the reliability of the automation of the environment construction is undermined. Therefore, a problem that the motivation of the infrastructure engineer working on the automation of the environment construction is lowered may occur. Therefore, an example embodiment for solving at least some of these problems will be described hereinafter.

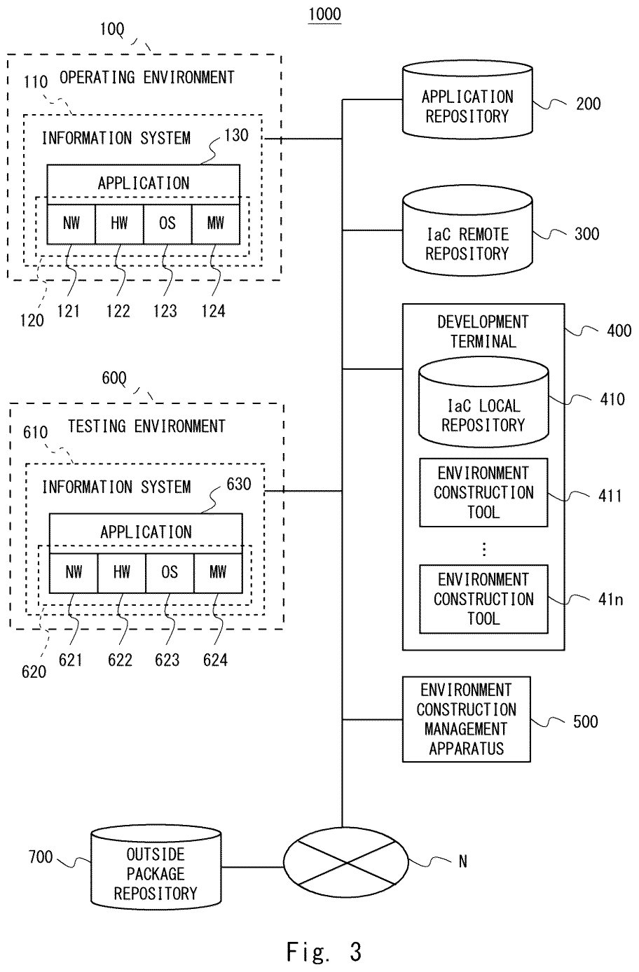

FIG. 3 is a block diagram showing an overall configuration of an environment construction management system 1000. The environment construction management system 1000 includes an operating environment 100, an application repository 200, an IaC remote repository 300, a development terminal 400, an environment construction management apparatus 500, a testing environment 600, and an outside package repository 700. The operating environment 100, the application repository 200, the IaC remote repository 300, the development terminal 400, the environment construction management apparatus 500, the testing environment 600, and the outside package repository 700 are connected to each other through a network N. Note that FIG. 3 shows an example in which the operating environment 100, the application repository 200, the IaC remote repository 300, the development terminal 400, the environment construction management apparatus 500, and the testing environment 600 are located in the same network, but the configuration of the environment construction management system 1000 is not limited this example. Note that the network N is a wired or wireless communication line.

The operating environment 100 is an environment in which an information system 110 is actually operated. The information system 110 includes an infrastructure configuration 120 and an application 130. The infrastructure configuration 120 includes a network element 121, a hardware element 122, an OS 123, and middleware 124. Note that the infrastructure configuration 120 is either a physical configuration or a virtual configuration, or a combination thereof, and includes configuration information thereof. The network element 121 is a communication apparatus or a network function in a server. The hardware element 122 is a computer such as a server or the like. The OS 123 is fundamental software running on the server or the like. The middleware 124 is software running on the OS 123 and is software for executing the application 130. The application 130 is a software group running on the middleware 124, and includes software to be operated and configuration information.

The testing environment 600 is an execution environment for a test, corresponds to the operating environment 100, in which an information system 610, which is a test version of the information system 110, operates. The information system 610 includes an infrastructure configuration 620 and an application 630. The infrastructure configuration 620 includes a network element 621, a hardware element 622, an OS 623, and middleware 624. Each of the infrastructure configuration 620, the network element 621, the hardware element 622, the OS 623, and the middleware 624 corresponds to a respective component or the like in the operating environment 100 described above. Further, the application 630 also includes software and configuration information for the testing environment 600 in the application 130 described above.

The application repository 200 is a database system that manages the versions of source files of programs and configuration files of the application 130 (and the application 630), and the version of the directory structure or the like.

The IaC remote repository 300 is a database system that manages the version of the IaC code in which the environment construction process for constructing the environment for the information system 110 is described. The IaC remote repository 300 may manage the version of each of a plurality of types of IaC codes. Alternatively, the IaC remote repository 300 may collectively manage the versions of a plurality of types of IaC codes for constructing the environment for a specific information system 110.

The development terminal 400 is an information processing apparatus operated by a person who develops the information system 110, especially an infrastructure engineer in charge of the environment construction. The development terminal 400 is used, for example, by the infrastructure engineer to develop the IaC code for the environment construction for the information systems 110 and 610. The development terminal 400 includes an IaC local repository 410, environment construction tools 411, . . . and 41n (n is a natural number equal to or greater than 2). The IaC local repository 410 is a database system for managing the version of the IaC code. The IaC local repository 410 is implemented by software for a repository operated in the development terminal 400 and a storage area. The IaC local repository 410 is a repository for managing the IaC code and the like created by the infrastructure engineer in the development terminal 400. Therefore, the IaC local repository 410 manages at least a part of the IaC managed in the IaC remote repository 300. Further, the IaC code registered (updated) in the IaC local repository 410 is synchronized to the IaC remote repository 300. That is, the IaC code committed to the IaC local repository 410 is also committed to the IaC remote repository 300.

Each of the environment construction tools 411 and the like is a tool of a different type or a different version (of the same type). The environment construction tools 411 and the like are used to implement an environment construction process for a designated environment by reading and executing a designated IaC code. Note that the environment construction tools 411 and the like can be considered to be an automatic execution engine for the IaC code. Further, some or all of the environment construction tools 411 and the like may be stored in a storage device located outside the development terminal 400 or stored in the server for the automatic execution engine.

Note that a plurality of IaC codes may be individually executed by using environment construction tools in order to construct the environment for the specific information system 110. In this case, all or some of the IaC codes may be executed by using environment construction tools of the same type, environment construction tools of the same type but having different versions, or environment construction tools of different types.

The outside package repository 700 is a repository installed in an environment outside the environment construction management system 1000. The outside package repository 700 is a database system that manages the versions of the IaC code, the environment construction tools 411 and the like, a software module group (outside package) and a configuration file which are referred to from the infrastructure configuration 120, and the directory structure or the like. The outside package is an example of reference information which is referred to from at least one of the IaC, the environment construction tools, and the operating environment for the information system.

Note that the application repository 200, the IaC remote repository 300, and the outside package repository 700 are a computer server group, and are implemented by software for repository operated in the respective servers and a storage area. Further, the infrastructure configuration 120 (especially configuration information) of the operating environment 100, the IaC remote repository 300, the IaC local repository 410, the environment construction tools 411 and the like, and the outside package repository 700 are examples of environmental elements.

The environment construction management apparatus 500 is an example of the environment construction management apparatus 10 described above. Note that the environment construction management apparatus 500 may be redundant over a plurality of servers, and each functional block thereof may be implemented by a plurality of computers.

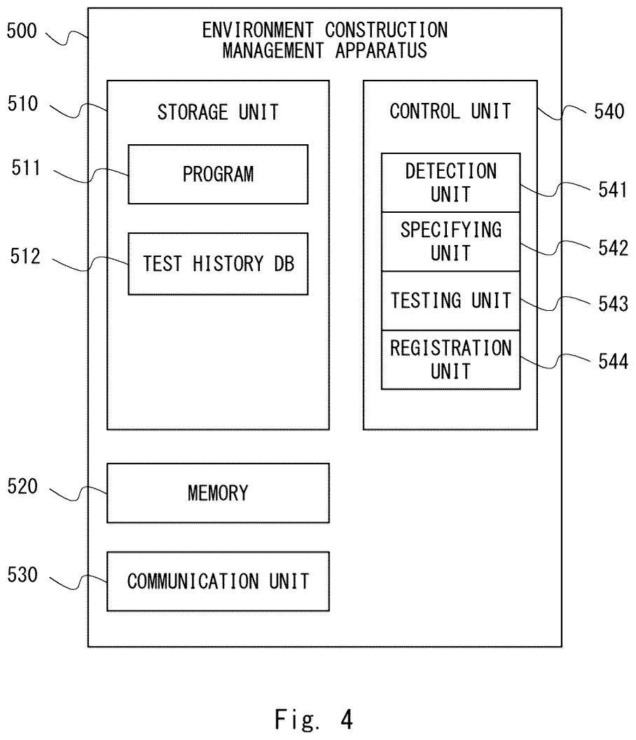

FIG. 4 is a block diagram showing the configuration of the environment construction management apparatus 500. The environment construction management apparatus 500 includes a storage unit 510, a memory 520, a communication unit 530, and a control unit 540. The storage unit 510 is an example of a non-volatile storage device such as a hard disk drive and a flash memory. In the storage unit 510, a program 511 and a test history DB (DataBase) 512 are stored. Further, some or all of the information items stored in the storage unit 510 may be stored in an external storage device. The program 511 is a computer program (environment construction management program) in which an environment construction management process and the like according to the second example embodiment are implemented. Note that in the storage unit 510, an OS may be stored as a configuration not shown.

The test history DB 512 is a database for managing history information in the execution of a test for the environment construction process executed for the testing environment 600. The history information is information in which the result of the execution of the environment construction process executed for the testing environment 600 is associated with a combination of version information (i.e., a combination of a plurality of pieces of version information) of the IaC code used in the execution, the environment construction tools, the configuration information of the operating environment, and the outside package.

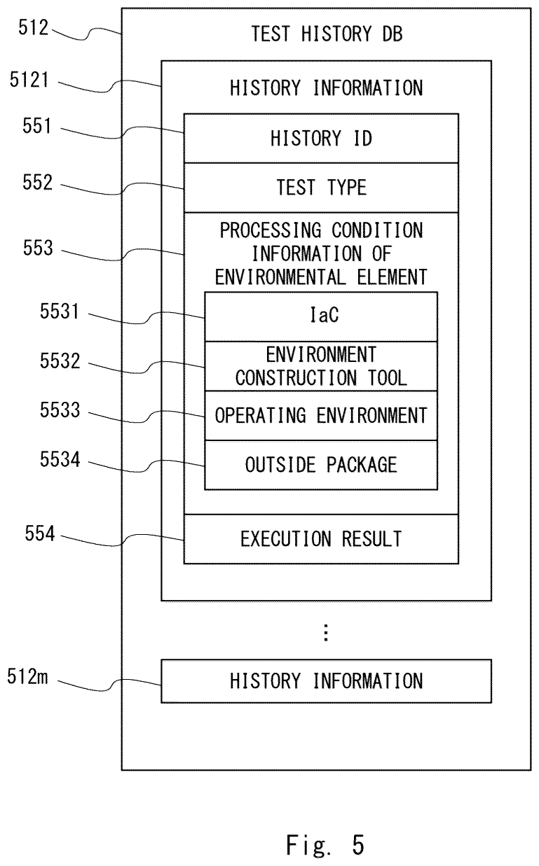

FIG. 5 shows the configuration of the test history DB 512. In the test history DB 512, history information (i.e., a plurality of pieces of history information) 5121 to 512m (m is a natural number equal to or greater than 2) is stored. The history information 5121 is information in which a history ID 551, a test type 552, environmental element processing condition information 553, and the execution result 554 are associated with each other. The history ID 551 is identification information of the history information. Note that the date and time of the execution of the test may be used instead of or in addition to the history ID 551. The test type 552 is information indicating the type of the operation checking test for the environment construction process, i.e., the type of the environment construction process. The test type 552 may be, for example, the type of the IaC code to be tested or the identification information or the like of the IaC code.

The environmental element processing condition information 553 is a combination of version information (i.e., a combination of a plurality of pieces of version information) of a plurality of environmental elements. The environmental element processing condition information 553 indicates a combination of version information of an IaC 5531, an environment construction tool 5532, an operating environment 5533, and an outside package 5534. The execution result 554 is information indicating the result of the test when the environment construction process of the test type 552 is executed for the testing environment 600 by using information corresponding to the environmental element processing condition information 553. Note that each of the history information 5122 (not shown), . . . and 512m has the same structure as that of the history information 5121.

The explanation is continued by referring to FIG. 4 again. The memory 520 is a volatile storage device such as a RAM (Random Access Memory) and serves as a storage area for temporarily holding information during the operation of the control unit 540. The communication unit 530 is a communication interface between the environment construction management apparatus 500 and the outside.

The control unit 540 is a processor, i.e., a control apparatus, for controlling various components of the environment construction management apparatus 500. The control unit 540 loads the OS and the program 511 from the storage unit 510 onto the memory 520, and executes the loaded OS and the program 511. In this way, the control unit 540 implements the functions of a detection unit 541, a specifying unit 542, a testing unit 543, and a registration unit 544.

The detection unit 541 is an example of the detection unit 11 described above. The detection unit 541 detects a change in an environmental element that could affect the environment construction process of the information system 110. Note that the environmental elements include the IaC, the environment construction tools 411 and the like, the configuration information (infrastructure configuration 120) of the operating environment 100 of the information system 110, and the outside package. Further, the changes in environmental elements include, for example, the update of the IaC, the update of any of the environment construction tools 411 and the like, the update of the configuration information of the operating environment 100 of the information system 110, and the update of the outside package. Therefore, the detection unit 541 detects a change(s) from a plurality of environmental elements. Further, the detection unit 541 according to this example embodiment receives a notification including the type of an environmental element and processing condition information corresponding to this environmental element from the outside, and by doing so, detects a change in the environmental element included in the notification.

The specifying unit 542 is an example of the specifying unit 12 described above. The specifying unit 542 specifies processing condition information corresponding to the environmental element in which the change has been detected by the detection unit 541. For example, the specifying unit 542 specifies processing condition information included in the notification. Further, the specifying unit 542 may specify the latest processing condition information corresponding to an environmental element(s) other than the environmental element in which the change has been detected.

The testing unit 543 is an example of the testing unit 13 described above. The testing unit 543 performs, for the testing environment 600, a test for the environment construction process using the processing condition information specified by the specifying unit 542. Specifically, the testing unit 543 performs a test for the environment construction process by using one of the environment construction tools 411 and the like which operate based on the IaC created for constructing the environment for the information system 110.

The registration unit 544 is an example of the registration unit 14 described above. The registration unit 544 registers, as history information, the result of the test by the testing unit 543 and the processing condition information specified by the specifying unit 542 in association with each other in the test history DB 512. In particular, when the result of the test indicates the success of the test, the registration unit 544 preferably registers, as history information, a combination of a plurality of pieces of latest processing condition information each of which corresponds to a respective one of a plurality of environmental elements and the result of the test in association with each other in the test history DB 512.

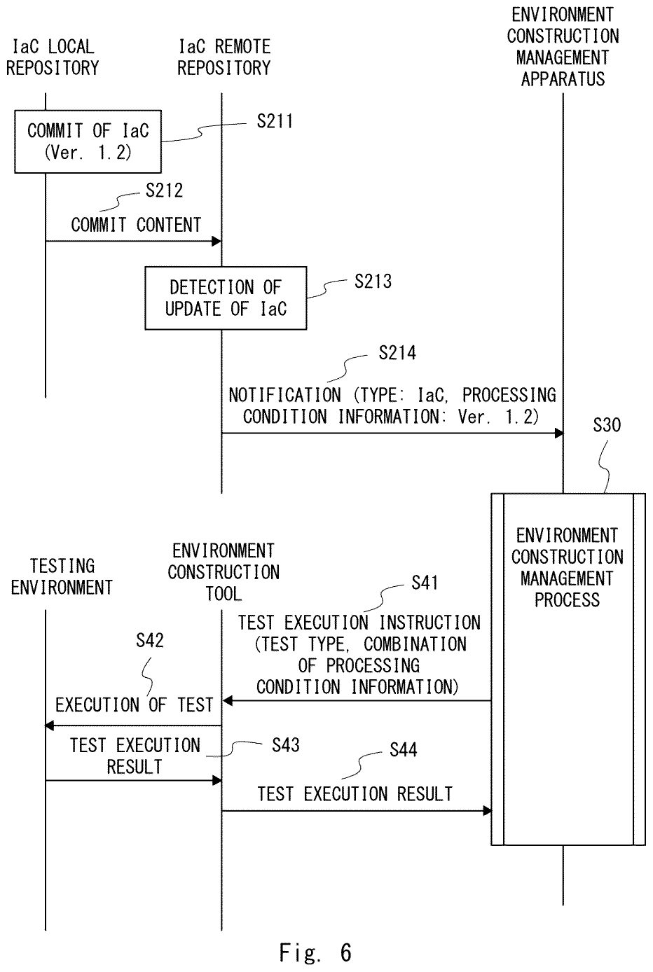

FIG. 6 is a sequence diagram showing a flow of an environment construction management process. A case where the IaC has been updated as an environmental element is shown hereinafter. Firstly, an infrastructure engineer modifies the IaC code of a specific version (e.g., Ver. 1.1). In this process, the development terminal 400 commits the modified IaC code to the IaC local repository 410 according to the operation performed by the infrastructure engineer (S211). In this example, it is assumed that the latest version of the IaC code of the specific type in the IaC local repository 410 has been updated from “Ver. 1.1” to “Ver. 1.2”. Note that in the update of version information, the same version information may be added to a set of all or some of a plurality of IaC codes for constructing the infrastructure configuration 120 of the information system 110.

In response to this, the IaC local repository 410 commits the same commit content to the IaC remote repository 300 for obtaining the synchronization (S212). Then, the IaC remote repository 300 detects the update of the IaC (S213). In response to the detection, the IaC remote repository 300 transmits a notification about the update of the IaC to the environment construction management apparatus 500 (S214). Note that the notification includes the type of the updated environmental element and the processing condition information. In this example, it is assumed that the type of the updated environmental element is “IaC”, and the processing condition information is “Ver. 1.2”.

Further, it is assumed that the IaC remote repository 300 is configured so as to transmit a notification to the environment construction management apparatus 500 when the update of the IaC is detected. For example, the IaC remote repository 300 transmits a notification to the environment construction management apparatus 500 through API (Application Programming Interface) communication such as Webhook when the update of the IaC is detected. Alternatively, a trigger setting (GitAction or the like) for the commitment for the IaC has already been made in the IaC remote repository 300, so that it may transmit a notification to the environment construction management apparatus 500 by the trigger setting. Note that instead of the IaC remote repository 300, the IaC local repository 410 may transmit a notification to the environment construction management apparatus 500 through API communication such as Webhook at the time of the update of the IaC. Alternatively, a trigger setting for the commitment for the IaC has already been made in the IaC local repository 410, so that it may transmit a notification to the environment construction management apparatus 500 by the trigger setting.

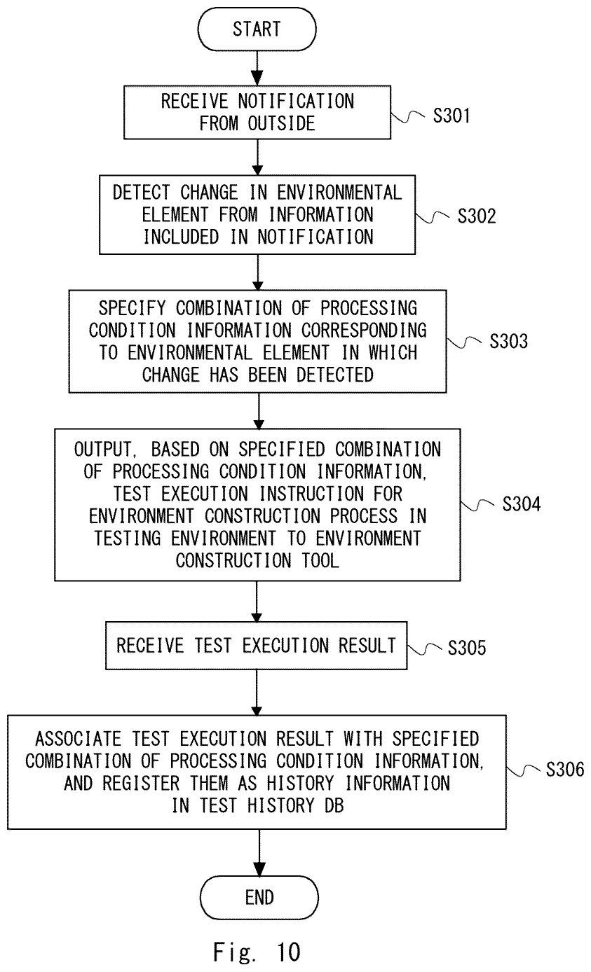

After that, the environment construction management apparatus 500 performs the environment construction process (S30). FIG. 10 is a flowchart showing a flow of an environment construction management process. Firstly, the environment construction management apparatus 500 receives a notification from the outside (S301). In this example, the environment construction management apparatus 500 receives the above-described notification from the IaC remote repository 300. Next, the environment construction management apparatus 500 detects a change in an environmental element based on information included in the received notification (S302). In this example, the environment construction management apparatus 500 detects, based on the type of an environmental element included in the notification, a fact that the “IaC” has been updated as a change in the environmental element. In this process, the environment construction management apparatus 500 may specify the type of the test in the operation checking test for the environment construction process based on the environmental element in which the change has been detected. Alternatively, the environment construction management apparatus 500 may specify a plurality of types of tests including all the types of IaC codes used for constructing the environment for the operating environment 100.

Then, the environment construction management apparatus 500 specifies a combination of processing condition information (i.e., a combination of pieces of processing condition information) corresponding to the environmental elements in which changes have been detected (S303). Specifically, the environment construction management apparatus 500 specifies version information “Ver. 1.2” of the IaC to be processed based on the processing condition information included in the notification. Further, the environment construction management apparatus 500 specifies a combination of the latest version information (i.e., a combination of pieces of latest version information) of environment construction tools, the configuration information of the operating environment 100, and the outside package, which are other environmental elements in which no changes have been detected. Specifically, the environment construction management apparatus 500 may refer to the test history DB 512 and specify a combination of the latest version information of environmental elements other than the environmental element in which the change has been detected. For example, the environment construction management apparatus 500 specifies the type and version information of the environment construction tool, the version information of the configuration information of the operating environment 100, and the version information or the like of the outside package, which are environmental elements other than the environmental element “IaC”.

Then, based on the combination of the processing condition information specified in the step S303, the environment construction management apparatus 500 outputs a test execution instruction for the environment construction process in the testing environment 600 to the environment construction tool (S304). For example, when the version information of the environment construction tool is included in the specified combination of processing condition information, the environment construction management apparatus 500 may output a test execution instruction in which the specified combination of processing condition information is designated to the environment construction tool 411 corresponding to the aforementioned version information. Further, the environment construction management apparatus 500 may designate the version information of the configuration information of the infrastructure configuration 620 of the testing environment 600 corresponding to the version information of the configuration information of the infrastructure configuration 120 of the operating environment 100 included in the specified combination of processing condition information, and output a test execution instruction. Further, the environment construction management apparatus 500 may specify the version information of the outside package included in the specified combination of processing condition information, and output a test execution instruction. Further, the environment construction management apparatus 500 may output a test execution instruction including the designation of the test type for which the operation checking test is to be performed. Note that the environment construction management apparatus 500 may output a module and an outside package corresponding to the version information specified in the step S303 to the environment construction tool 411 together with the test execution instruction.

The explanation is continued by referring to FIG. 6 again. For example, the environment construction tool 411 receives the test execution instruction from the environment construction management apparatus 500 (S41). Based on the received test execution instruction, the environment construction tool 411 performs the test for the environment construction process for the testing environment 600 (S42). For example, when the test type is designated in the test execution instruction, the environment construction tool 411 may perform a test for each test type. That is, the environment construction tool 411 acquires the type of the IaC code corresponding to the test type and the IaC code corresponding to the version information of the IaC included in the test execution instruction. For example, the environment construction tool 411 acquires the IaC code (group) corresponding to the version information of the IaC included in the test execution instruction from the IaC remote repository 300. Then, the environment construction tool 411 performs the test for the environment construction process for the testing environment 600 by using the IaC code of the acquired version. Further, the environment construction tool 411 designates the test type and the version information of the configuration information of the testing environment 600 corresponding to the version information of the configuration information of the operating environment 100 included in the test execution instruction, and performs the test for the environment construction process for the testing environment 600. Further, the environment construction tool 411 acquires the outside package or the like corresponding to the version information of the outside package included in the test execution instruction from the outside package repository 700. Then, the environment construction tool 411 performs the test for the environment construction process for the testing environment 600 by using the outside package of the acquired version. Alternatively, the environment construction tool 411 may refer to the outside package repository 700 during the execution of itself, and determine whether or not there is the outside package corresponding to the version information of the outside package included in the test execution instruction. Then, when there is the outside package corresponding to the version information, the environment construction tool 411 performs the test for the environment construction process for the testing environment 600 by referring to this outside package.

After that, the environment construction tool 411 acquires the test execution result of the environment construction process from the testing environment 600 (S43). For example, the environment construction tool 411 may acquire the test execution result by acquiring a return value of the environment construction process or executing a checking command for the infrastructure configuration 620 or the like of the testing environment 600 after the environment construction process. Then, the environment construction tool 411 outputs the acquired test execution result to the environment construction management apparatus 500 (S44).

The explanation is continued by referring to FIG. 10 again. In response to the process in the step S44 in FIG. 6, the environment construction management apparatus 500 receives the test execution result from the environment construction tool 411 (S305). Then, the environment construction management apparatus 500 associates the test execution result with the combination of processing condition information specified in the step S303, and registers them as history information in the test history DB 512 (S306). Specifically, the environment construction management apparatus 500 issues a unique history ID 551 corresponding to the execution of the test performed at this time. Then, the environment construction management apparatus 500 generates history information 5121 by associating the issued history ID 551, the test type 552 of the executed test, the combination of processing condition information 553 of the environmental elements specified in the step S303, and the test execution result received in the step S305 with each other. Then, the environment construction management apparatus 500 registers the generated history information 5121 in the test history DB 512.

Note that in the step S304, the environment construction management apparatus 500 may output, to the development terminal 400, a test execution instruction in which all the test types to be subjected to the operation checking test are designated. In this case, in the step S42, the development terminal 400 performs the test for the environment construction process a plurality of times by using respective environment construction tools corresponding to the test types designated in the test execution instruction. That is, the development terminal 400 performs the test for each of the test types. Then, each time the development terminal 400 acquires the test execution result of the executed test, it outputs the acquired test execution result to the environment construction management apparatus 500. Alternatively, the development terminal 400 may collectively output the execution results of the executed tests for all the test types designated in one test execution instruction to the environment construction management apparatus 500. In this case, the environment construction management apparatus 500 generates history information for each of the test types and registers each history information in the test history DB 512.

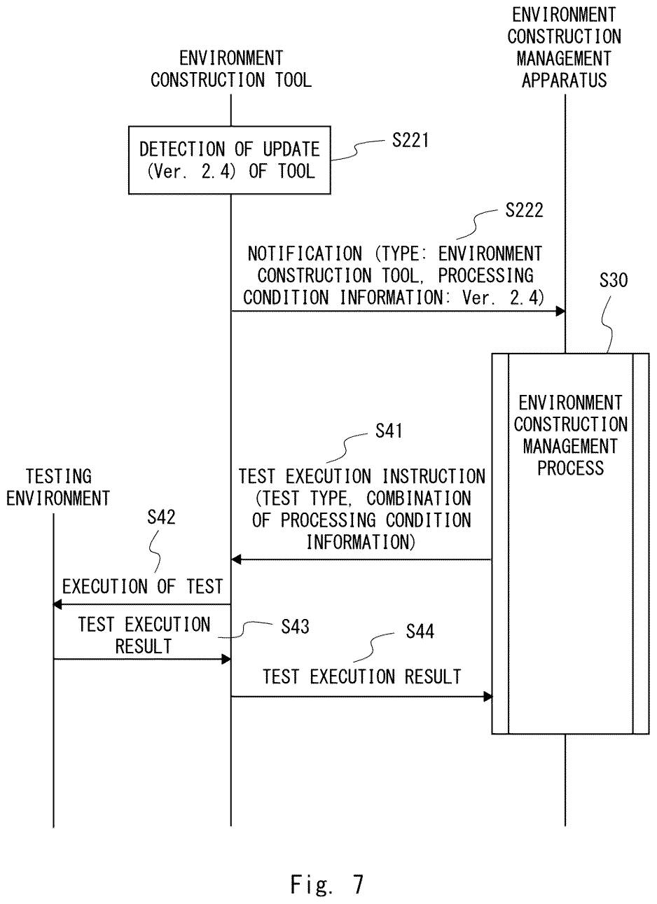

FIG. 7 is a sequence diagram showing a flow of an environment construction management process. In this example, a case where the environment construction tool 411 is updated as an environmental element is shown. Further, explanations of processes which are the same as those in FIGS. 6 and 10 are omitted as appropriate. For example, the development terminal 400 periodically checks updates of the environment construction tools 411 and the like. It is assumed that the development terminal 400 is configured to perform an update checking process for each environment construction tool, and to transmit a notification to the environment construction management apparatus 500 when the update of an environment construction tool is detected. Specifically, the development terminal 400 transmits an update checking request for the versions corresponding to the environment construction tools 411 and the like to the server which has provided the environment construction tools 411 and the like, and thereby determines whether or not the update has been made and determines the version based on the received update checking result. In this example, it is assumed that the environment construction tool 411 has been updated from “Ver. 2.3” to “Ver. 2.4”. Alternatively, each of the environment construction tools 411 may be configured to perform an update checking process for its own environment construction tool, and to transmit a notification to the environment construction management apparatus 500 when the update is detected.

Note that the development terminal 400 or the environment construction tool 411 detects the update of the environment construction tool 411 (S221). In response to the detection, the development terminal 400 or the environment construction tool 411 transmits a notification about the update of the environment construction tool to the environment construction management apparatus 500 (S222). In this example, the notification includes the type “environment construction tool” of the updated environmental element and the processing condition information “Ver. 2.4”.

For example, when the development terminal 400 or the environment construction tool 411 or the like detects the update of the environment construction tool, it transmits a notification to the environment construction management apparatus 500 through API communication such as Webhook. Alternatively, in the development terminal 400 or the environment construction tool 411 or the like, a trigger setting has already been made for a change in a setting file or the status of the environment construction tool, and it may transmit a notification to the environment construction management apparatus 500 by the trigger setting.

In response to this, the environment construction management apparatus 500 receives the above-described notification from the development terminal 400 or the environment construction tool 411 (S301 in FIG. 10). Next, the environment construction management apparatus 500 detects the fact that the “environment construction tool” has been updated based on the type of the environmental element included in the notification as a change in the environmental element (S302 in FIG. 10). Then, the environment construction management apparatus 500 specifies the version information “Ver. 2.4” of the environment construction tool for which the test is to be performed based on the processing condition information included in the notification. Further, the environment construction management apparatus 500 specifies a combination of the latest version information of the IaC, the configuration information of the operating environment 100, and the outside package, which are other environmental elements in which no changes has been detected (S303 in FIG. 10). After that, the environment construction management apparatus 500 executes the steps S304 to S306 shown in FIG. 10 described above. Further, the environment construction tool 411 executes the steps S41 to S44 shown in FIG. 7 in a manner similar to the executions in FIG. 6 described above.

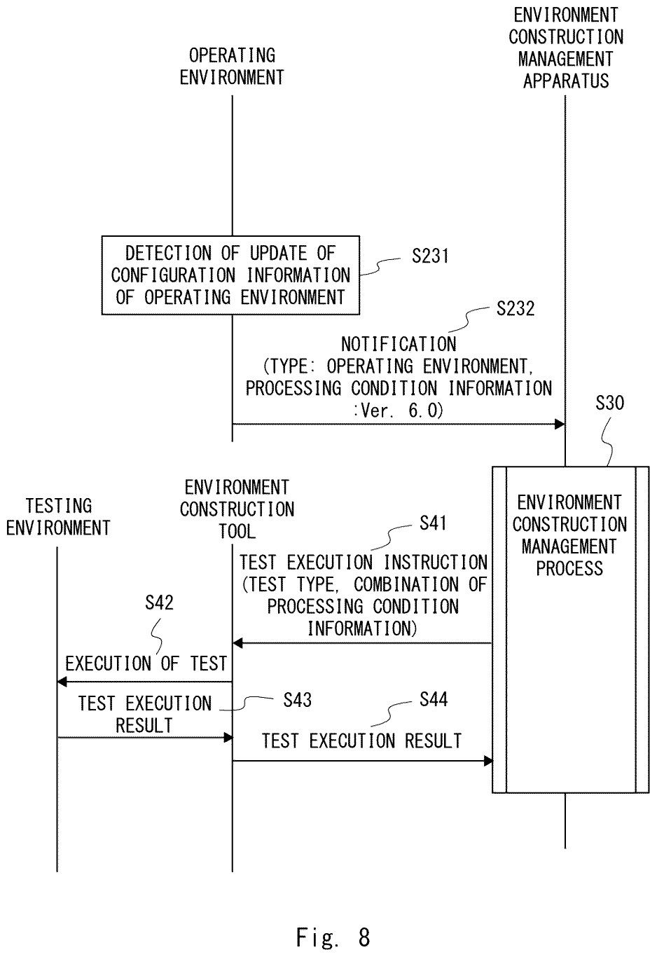

FIG. 8 is a sequence diagram showing a flow of an environment construction management process. In this example, a case where the infrastructure configuration 120 (configuration information) of the operating environment 100 is updated as an environmental element is shown. Further, explanations of processes which are the same as those in FIGS. 6, 7 and 10 are omitted as appropriate. In the operating environment 100, the configuration information could be changed not only by the infrastructure engineer but also by other various persons concerned such as the person who develops the application 130 and the person in charge of the operation. The configuration information includes information about the infrastructure configuration 120, for example, the network element 121, the hardware element 122, the OS 123 and the middleware 124. The configuration information includes, for example, the network configuration and settings, the hardware configuration and environment variables, version information of patches applied to the OS, the middleware, the firmware, and the like. In the operating environment 100, a monitoring tool may be operated as a configuration not shown. For example, the monitoring tool which is running on the server in the operating environment 100 all the times may be configured to periodically monitor the update of the configuration information of the infrastructure configuration 120, and to transmit a notification to the environment construction management apparatus 500 when the update is detected. In this example, it is assumed that the infrastructure configuration 120 of the operating environment 100 has been updated from “Ver. 5.7” to “Ver. 6.0”.

Note that (the monitoring tool of) the operating environment 100 detects the update of the configuration information of the operating environment 100 (S231). In response to the detection, (the monitoring tool of) the operating environment 100 transmits a notification about the update of the infrastructure configuration 120 of the operating environment 100 to the environment construction management apparatus 500 (S232). In this example, the notification includes the type “operating environment” of the updated environmental element, and the processing condition information “Ver. 6.0”.

For example, when (the monitoring tool of) the operating environment 100 detects the update of the infrastructure configuration 120 of the operating environment 100, it transmits a notification to the environment construction management apparatus 500 through API communication such as Webhook. Alternatively, in (the monitoring tool of) the operating environment 100, a trigger setting has already been made for a change in the configuration information, and it may transmit a notification to the environment construction management apparatus 500 by the trigger setting.

In response to this, the environment construction management apparatus 500 receives the above-described notification from (the monitoring tool of) the operating environment 100 (S301 in FIG. 10). Next, the environment construction management apparatus 500 detects the fact that the “operating environment” has been updated based on the type of the environmental element included in the notification as a change in the environmental element (S302 in FIG. 10). Then, the environment construction management apparatus 500 specifies the version information “Ver. 6.0” of (the configuration information of) the operating environment for which the test is to be performed based on the processing condition information included in the notification. For example, the environment construction management apparatus 500 specifies the version information of the configuration information of the infrastructure configuration 620 of the testing environment 600 corresponding to the specified version information of the configuration information of the infrastructure configuration 120 of the operating environment 100. Further, the environment construction management apparatus 500 specifies a combination of the latest version information (i.e., a combination of pieces of latest version information) of the IaC, the environment construction tool, and the outside package, which are other environmental elements in which no changes has been detected (S303 in FIG. 10). After that, the environment construction management apparatus 500 executes the steps S304 to S306 shown in FIG. 10 described above. Further, the environment construction tool 411 executes the steps S41 to S44 shown in FIG. 8 in a manner similar to the executions in FIG. 6 described above.

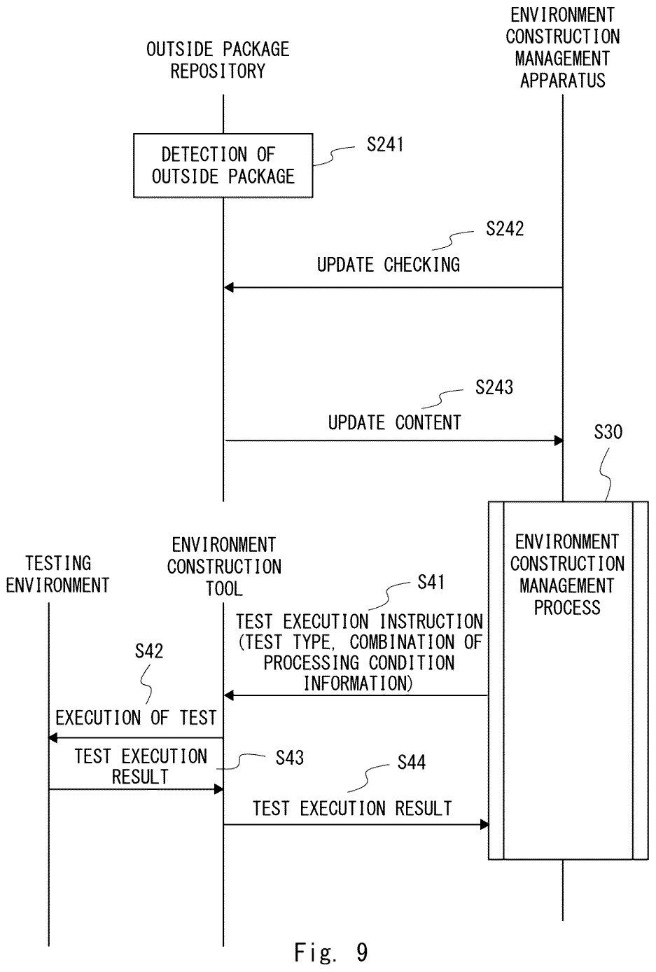

FIG. 9 is a sequence diagram showing a flow of an environment construction management process. In this example, a case where the outside package is updated as an environmental element is shown. Further, explanations of processes which are the same as those in FIGS. 6, 7, 8 and 10 are omitted as appropriate. The name (file name), the package content, the path to the storage area, and the like of the outside package managed by the outside package repository 700 could be updated at irregular intervals by the provider. Further, in the environment construction management apparatus 500, a monitoring tool may be operated as a configuration not shown. For example, the monitoring tool which is running on the environment construction management apparatus 500 all the times periodically transmits update checking in order to monitor the update of information about the outside package in the outside package repository 700. Note that the information about the outside package may be the name (file name), the package content, the path to the storage area, and the like of the outside package, which is an example of the reference information described above. In this example, it is assumed that the reference information in the outside package repository 700 has been updated from “Ver. 8.1” to “Ver. 8.2”.

Here, it is assumed that the information about the outside package (reference information) in the outside package repository 700 has been updated (S241). After that, the environment construction management apparatus 500 transmits update checking to the outside package repository 700 (S242). In response to this, the outside package repository 700 returns the updated content of the information about the outside package (S243).

In response to this, when the environment construction management apparatus 500 receives the updated content from the outside package repository 700, it detects the fact that the “outside package” has been updated based on the updated content as a change in the environmental element. Further, the environment construction management apparatus 500 specifies the version information “Ver. 8.2” of the outside package based on the updated content.

Note that similarly to the IaC remote repository 300 described above, the outside package repository 700 may be configured to transmit a notification to the environment construction management apparatus 500 when the update of the reference information is detected. In this case, the notification includes the type “outside package” of the updated environmental element and the processing condition information “Ver. 8.2”. For example, when the outside package repository 700 detects the update of the reference information, it transmits a notification to the environment construction management apparatus 500 through API communication such as Webhook. Alternatively, a trigger setting for the commitment for the IaC has already been made in the outside package repository 700, so that it may transmit a notification to the environment construction management apparatus 500 by the trigger setting.

In this case, the environment construction management apparatus 500 receives the above-described notification from the outside package repository 700 (S301 in FIG. 10). Next, the environment construction management apparatus 500 detects, based on the type of an environmental element included in the notification, a fact that the “outside package” has been updated as a change in the environmental element (S302 in FIG. 10). Then, the environment construction management apparatus 500 specifies the version information “Ver. 8.2” of the outside package based on the processing condition information included in the notification. Further, the environment construction management apparatus 500 specifies a combination of the latest version information of the IaC, the environment construction tool, and the configuration information of the operating environment, which are other environmental elements in which no changes has been detected (S303 in FIG. 10).

After that, the environment construction management apparatus 500 executes the steps S304 to S306 shown in FIG. 10 described above. Further, the environment construction tool 411 executes the steps S41 to S44 shown in FIG. 9 in a manner similar to the executions in FIG. 6 described above.

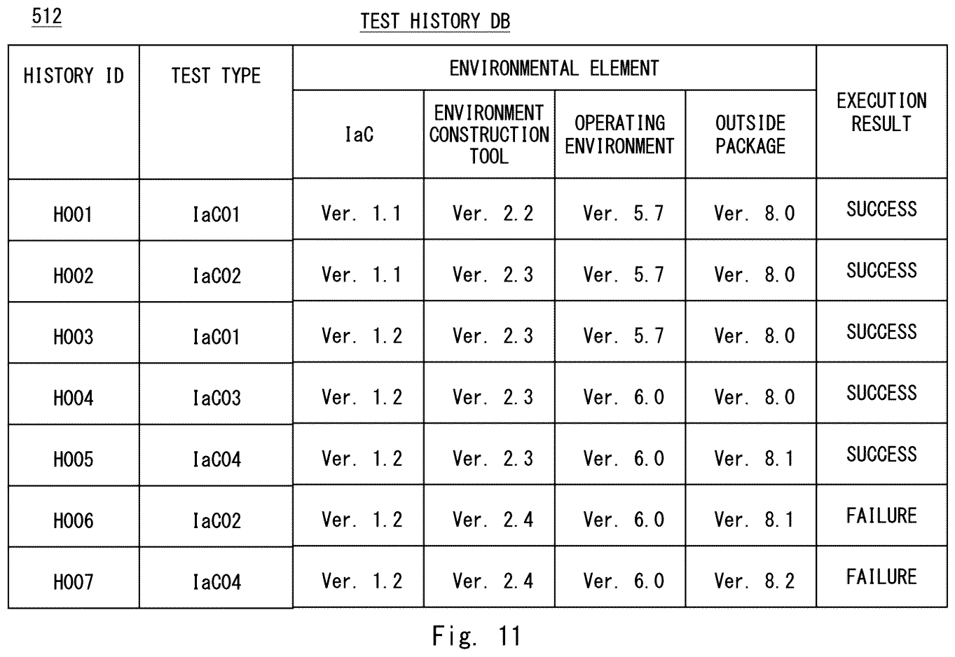

FIG. 11 shows an example of the test history DB 512. For example, the history ID “H001” indicates, for the test type “IaC01”, that an environment construction process was executed by a combination of the versions of environmental elements corresponding thereto, and the test execution result was “success”. The combination of the versions of the environmental elements corresponding to the history ID “H001” indicates that: the IaC “Ver. 1.1”; the environment construction tool “Ver. 2.2”; (the configuration information of) the operating environment “Ver. 5.7”; and the outside package “Ver. 8.0”. Further, the history ID “H001” indicates that the execution result was “success”.

Further, the history ID “H002” indicates, for the test type “IaC02” different from the test type “H001”, that among the combinations of the versions of environmental elements, the versions of the environment construction tools are different, i.e., are “Ver. 2.2” and “Ver. 2.3”. That is, as shown in FIG. 7 described above, the history ID “H002” indicates the combination of processing condition information when the test was executed upon the detection of the update of the environment construction tool, and its execution result “success”.

Further, the history ID “H003” indicates, for the same test type “IaC01” as that of “H001”, that, among the combinations of versions of environmental elements, the version “Ver. 1.2” of the IaC and the version “Ver. 2.3” of the environment construction tool are different from those of “H001”. However, it indicates that the history ID “H003” and the history ID “H002” which has been executed most recently have the same version “Ver. 2.3” for the environment construction tool, that is, it indicates that the version of the environment construction tool has not been updated. Further, as shown in FIG. 6 described above, the history ID “H003” indicates the combination of processing condition information when the test was executed upon the detection of the update of the IaC, and its execution result “success”.

Further, the history IDs “H004” and “H005” indicate that the test execution results for the test types “IaC03” and “IaC04” different from those of “H001” to “H003” executed up to that time were both “successes”. The history ID “H004” is the test execution result when the above-described configuration information of the operating environment shown in FIG. 8 was updated from “Ver. 5.7” to “Ver. 6.0”. Further, the history ID “H005” is the test execution result when the above-described outside package shown in FIG. 9 was updated from “Ver. 8.0” to “Ver. 8.1”.

Further, the history ID “H006” indicates, for the same test type “IaC02” as that of “H002”, that the versions of the four types of environmental elements are all different from that of “H002”. However, it indicates that the history ID “H006” and the history ID “H005” which has been executed most recently have the same version “Ver. 1.2” for the IaC, the same version “Ver. 6.0” for the configuration information of the operating environment, and the same version “Ver. 8.1” for the outside package, that is, it indicates that they have not been updated. Further, as shown in FIG. 7 described above, the history ID “H006” indicates the combination of processing condition information when the test was executed upon the detection of the update of the environment construction tool, and its execution result “failure”.

Further, the history ID “H007” indicates, for the same test type “IaC04” as that of “H005”, that, among the combinations of versions of environmental elements, the version “Ver. 2.4” of the environment construction tool and the version “Ver. 8.1” of the outside package are different from those of “H005”. However, it indicates that the history ID “H007” and the history ID “H006” which has been executed most recently have the same version “Ver. 2.4” for the environment construction tool, that is, it indicates that the version of the environment construction tool has not been updated. Further, as shown in FIG. 9 described above, the history ID “H007” indicates the combination of processing condition information when the test was executed upon the detection of the update of the outside package, and its execution result “failure”.

As described above, in this example embodiment, a change in the IaC code itself, the environment construction tool or the execution environment (operating environment or the like), or the outside package or the like to which they refer is detected as an external factor (environmental element) that could affect the operation of the environment construction process using the IaC. Further, when a change in an external factor is detected, the operation checking test for the environment construction process is performed using the version of the changed environmental element on the assumption that other environmental elements are the same as the latest ones. Then, the execution result of the operation checking test and a combination of the versions of the environmental elements used in the operation checking test are associated with each other and recorded as history information. Therefore, the infrastructure engineer or the like can recognize the deterioration of the IaC early based on the contents of the test history DB 512, and can take appropriate measures (such as the correction of the IaC or the like). Therefore, it is possible to keep the freshness of the IaC, and to maintain the guarantee of the normal operation of the IaC irrespective of changes in factors that could otherwise affect the operation of the IaC. That is, it is possible to support the maintenance and management of the operating environment for the IaC.

In particular, the operation checking test is performed in a pseudo manner for the testing environment 600 instead of performing for the operating environment 100. Therefore, it is possible to support the maintenance and management of the operating environment for the IaC without affecting the actual operation. Further, the operation checking test may be performed for some of a plurality of types of IaCs. In this way, it is possible to support the maintenance and management of the operating environment for the IaC in an efficient and effective manner.

### Third Example Embodiment

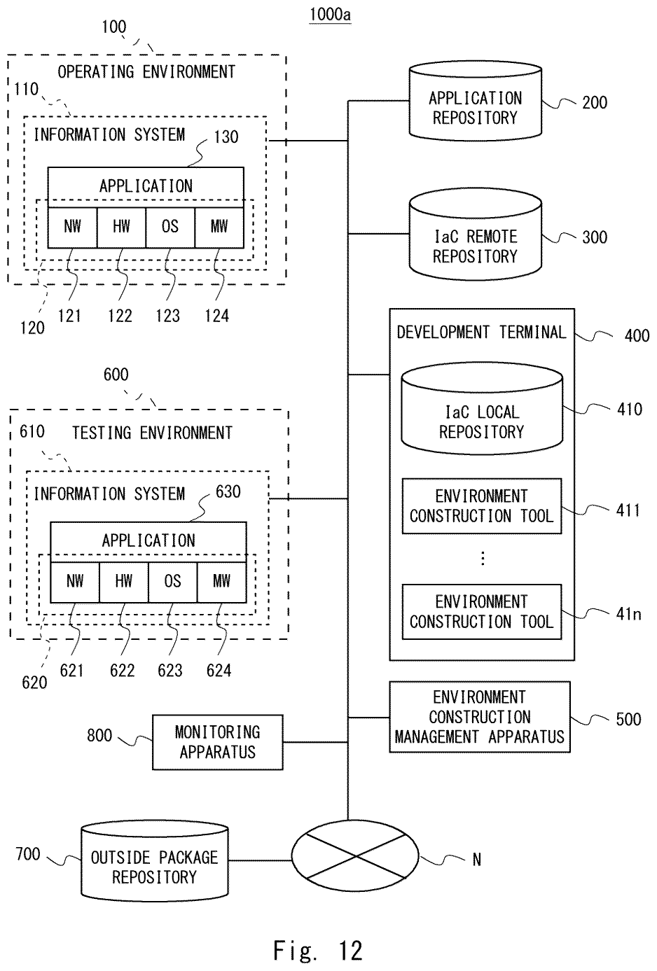

A third example embodiment is another specific example of the first example embodiment described above. FIG. 12 is a block diagram showing an overall configuration of an environment construction management system 1000a. The environment construction management system 1000a includes an additional monitoring apparatus 800 as compared to the configuration shown in FIG. 3. Note that the rest of the configuration of the environment construction management system 1000a is similar to that of the above-described environment construction management system 1000, and therefore the redundant description thereof will be omitted as appropriate.

The monitoring apparatus 800 is an information processing apparatus that periodically monitors updates of a plurality of environmental elements in the information system 110 and, when an update is detected, transmits a notification about the update to the environment construction management apparatus 500. The monitoring apparatus 800 may transmit the above-described update checking to the monitoring target and transmit a notification about an update to the environment construction management apparatus 500 according to the received update content. For example, the monitoring apparatus 800 monitors the update of the IaC in the IaC local repository 410 or the IaC remote repository 300. Further, the monitoring apparatus 800 also monitors the updates of the environment construction tools 411 and the like, the configuration information of the operating environment 100, and the outside package repository 700.

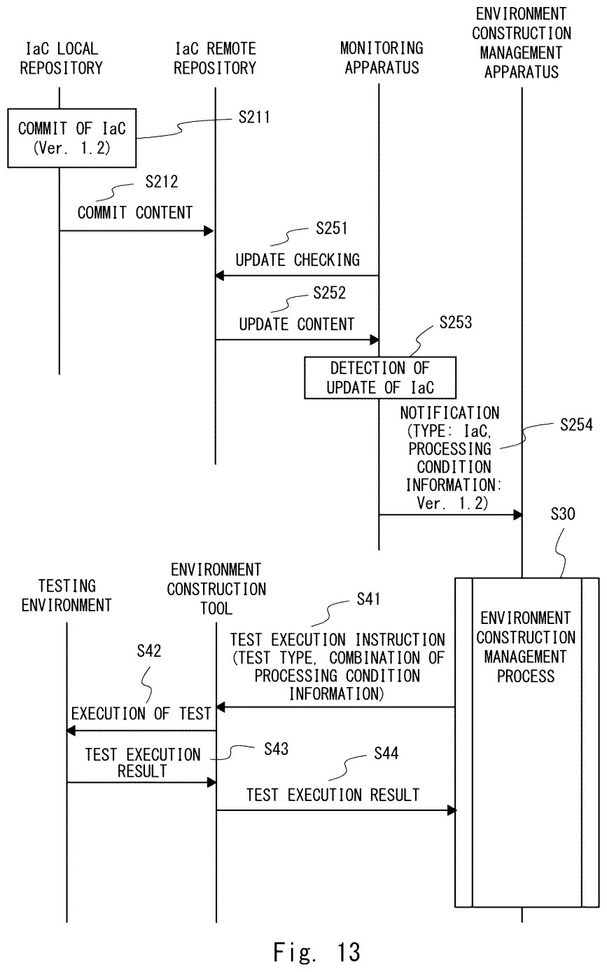

FIG. 13 is a sequence diagram showing a flow of an environment construction management process. Steps S211 and S212 are similar to those in FIG. 6. After that, the monitoring apparatus 800 transmits update checking to the IaC remote repository 300 (S251). In response to this, the IaC remote repository 300 returns the update content of the IaC (S252). Then, the monitoring apparatus 800 detects the update of the IaC based on the received update content (S253). In response to the detection, the monitoring apparatus 800 transmits a notification about the update of the IaC to the environment construction management apparatus 500 (S254).

Note that the monitoring apparatus 800 also periodically transmits update checking to the environment construction tools 411 and the like, the infrastructure configuration 120 of the operating environment 100, and the outside package repository 700, and when an update is detected, transmits a notification corresponding thereto to the environment construction management apparatus 500. After that, the environment construction management apparatus 500 performs the environment construction process according to the received notification as described above (S30). Therefore, this example embodiment also provides effects similar to those of the above-described second example embodiment.

### Fourth Example Embodiment

A fourth example embodiment is another specific example of the first example embodiment described above. An environment construction management apparatus according to the fourth example embodiment is equipped with a monitoring function therein. Note that the rest of the configuration of the environment construction management system according to the fourth example embodiment is similar to that of the above-described environment construction management system 1000, and therefore the redundant description thereof will be omitted as appropriate.

The environment construction management apparatus 500 according to the fourth example embodiment periodically monitors the updates of a plurality of environmental elements in the information system 110, and when an update is detected, performs the process for specifying a combination of processing condition information and the subsequent processes described above. Specifically, the environment construction management apparatus 500 transmits the above-described update checking to the monitoring target, and detects a change in an environmental element according to the received update content. For example, the monitoring apparatus 800 monitors the update of the IaC in the IaC local repository 410 or the IaC remote repository 300. Further, the monitoring apparatus 800 also monitors the updates of the environment construction tools 411 and the like, the configuration information of the operating environment 100, and the outside package repository 700.

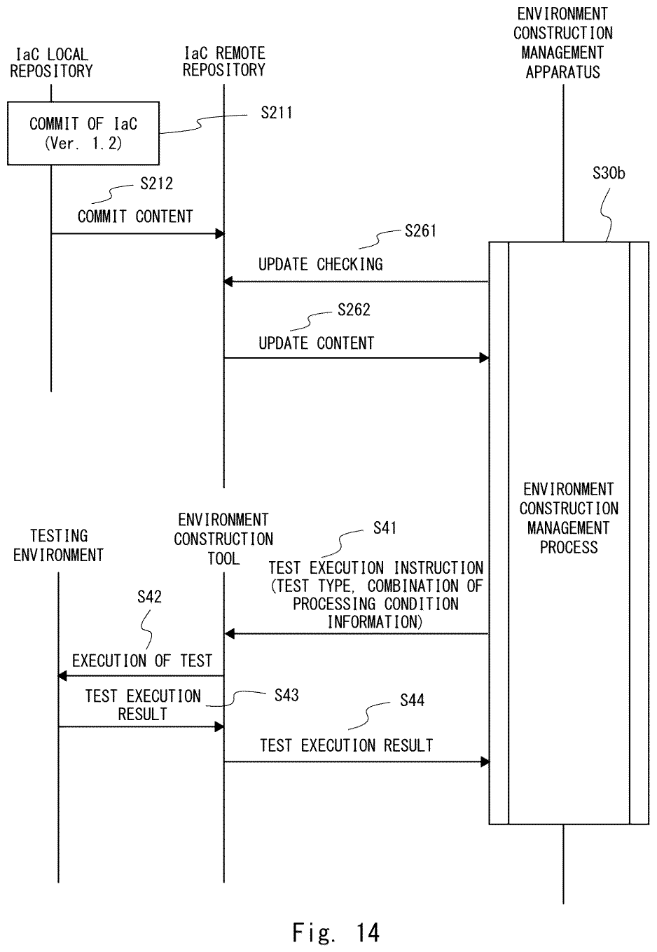

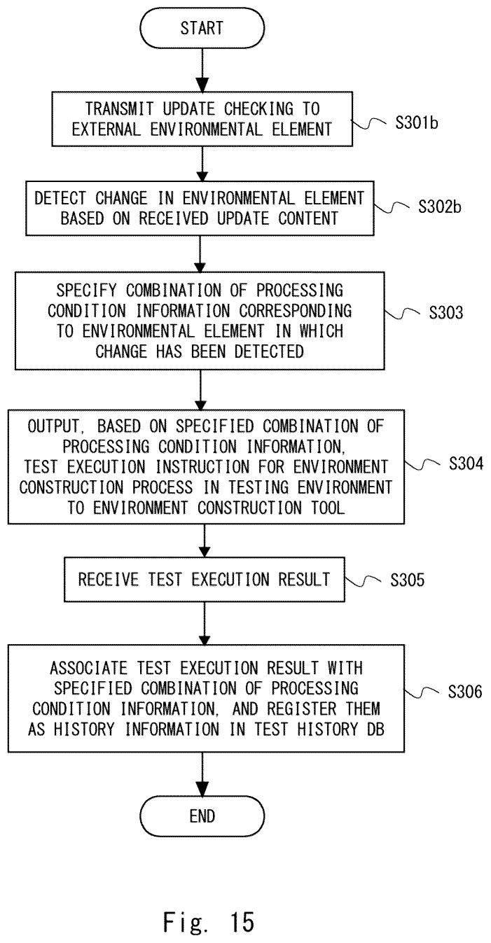

FIG. 14 is a sequence diagram showing a flow of an environment construction management process. Further, FIG. 15 is a flowchart showing a flow of an environment construction management process according to the fourth example embodiment. Note that steps S211 and S212 are similar to those in FIG. 6 described above. After that, update checking is transmitted to an external environmental element (S301b). Then, the environment construction management apparatus 500 detects a change in an environmental element based on the received update content (S302b).

In the example shown in FIG. 14, the environment construction management apparatus 500 transmits update checking to the IaC remote repository 300 (S261). In response to this, the IaC remote repository 300 returns the update content of the IaC (S262). After that, the environment construction management apparatus 500 detects the update of the IaC based on the received update content (S302b). After that, the environment construction management apparatus 500 performs the processes in the step S303 and the subsequent steps as described above. Therefore, this example embodiment also provides effects similar to those of the above-described second example embodiment.

### Other Example Embodiment

In the above-described examples, the program includes a set of instructions (or software codes) that, when being loaded into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Note that the present disclosure is not limited to the above-described example embodiments, and they may be modified as appropriate without departing from the scope and spirit of the disclosure. Further, the present disclosure may be implemented by combining two or more of the example embodiments as appropriate.

The whole or part of the example embodiments disclosed above can be described as, but not limited to, the following supplementary notes.

### (Supplementary Note A1)

An environment construction management apparatus comprising:
detection means for detecting a change in an environmental element that could affect an environment construction process of a predetermined information system;
specifying means for specifying processing condition information corresponding to an environmental element in which a change is detected;
testing means for performing a test for the environment construction process using the specified processing condition information for a testing environment for the information system; and
registration means for registering, as history information, a result of the test and the specified processing condition information in association with each other.

### (Supplementary Note A2)

The environment construction management apparatus described in Supplementary note A1, wherein the testing means performs a test for the environment construction process by using an environment construction tool configured to operate based on an IaC (Infrastructure as code) created for constructing an environment for the information system.

### (Supplementary Note A3)

The environment construction management apparatus described in Supplementary note A2, wherein the change in the environmental element includes an update of the IaC.

### (Supplementary Note A4)

The environment construction management apparatus described in Supplementary note A2, wherein the change in the environmental element includes an update of the environment construction tool.

### (Supplementary Note A5)

The environment construction management apparatus described in Supplementary note A2, wherein the change in the environmental element includes an update of configuration information of an operating environment for the information system.

### (Supplementary Note A6)

The environment construction management apparatus described in Supplementary note A2, wherein the change in the environmental element includes an update in regard to reference information which is referred to from at least one of the IaC, the environment construction tool, and the operating environment for the information system.

### (Supplementary Note A7)

The environment construction management apparatus described in Supplementary note A1 or A2, wherein the detection means detects the change from among a plurality of environmental elements.

### (Supplementary Note A8)

The environment construction management apparatus described in Supplementary note A7, wherein when a result of the test indicates success of the test, the registration means registers, as the history information, a combination of latest processing condition information respectively corresponding to the plurality of environmental elements and the result of the test in association with each other.

### (Supplementary Note A9)

The environment construction management apparatus described in Supplementary note A1 or A2, wherein
the detection means receives a notification including a type of the environmental element and the processing condition information corresponding to the environmental element from outside, and thereby detects a change in the environmental element included in the notification, and
the specifying means specifies the processing condition information included in the notification.

### (Supplementary Note B1)

An environment construction management system comprising:
a storage device; and
an information processing apparatus connected to the storage device, wherein
the information processing apparatus comprises:
detection means for detecting a change in an environmental element that could affect an environment construction process of a predetermined information system;
specifying means for specifying processing condition information corresponding to an environmental element in which a change is detected;
testing means for performing a test for the environment construction process using the specified processing condition information for a testing environment for the information system; and
registration means for registering, as history information, a result of the test and the specified processing condition information in association with each other in the storage device.

### (Supplementary Note B2)

The environment construction management system described in Supplementary note B1, further comprising notification means for transmitting, in response to an update in regard to the environmental element, a notification including a type of the environmental element and the processing condition information corresponding to the environmental element to an information processing apparatus, wherein
the detection means receives the notification from the notification means, and thereby detects a change in the environmental element included in the notification, and
the specifying means specifies the processing condition information included in the notification.

### (Supplementary Note C1)

An environment construction management method, wherein a computer:
detects a change in an environmental element that could affect an environment construction process of a predetermined information system;
specifies processing condition information corresponding to an environmental element in which a change is detected;
performs a test for the environment construction process using the specified processing condition information for a testing environment for the information system; and
registers, as history information, a result of the test and the specified processing condition information in association with each other in a storage device.

### (Supplementary Note D1)

An environment construction management program for causing a computer to perform:
detection means for detecting a change in an environmental element that could affect an environment construction process of a predetermined information system;
specifying means for specifying processing condition information corresponding to an environmental element in which a change is detected;
testing means for performing a test for the environment construction process using the specified processing condition information for a testing environment for the information system; and
registration means for registering, as history information, a result of the test and the specified processing condition information in association with each other.

The present invention has been described above with reference to the example embodiments (and examples), but the present invention is not limited to the above-described example embodiments (and examples). Various modifications that can be understood by those skilled in the art can be made to the configuration and details of the present invention within the scope of the invention.

This application is based upon and claims the benefit of priority from Japanese patent application No. 2022-209128, filed on Dec. 27, 2022, the disclosure of which is incorporated herein in its entirety by reference.

### REFERENCE SIGNS LIST

10 ENVIRONMENT CONSTRUCTION MANAGEMENT APPARATUS
11 DETECTION UNIT
12 SPECIFYING UNIT
13 TESTING UNIT
14 REGISTRATION UNIT
1000 ENVIRONMENT CONSTRUCTION MANAGEMENT SYSTEM
1000a ENVIRONMENT CONSTRUCTION MANAGEMENT SYSTEM
100 OPERATING ENVIRONMENT
110 INFORMATION SYSTEM
120 INFRASTRUCTURE CONFIGURATION
121 NETWORK ELEMENT
122 HARDWARE ELEMENT
123 OS
124 MIDDLEWARE
130 APPLICATION
200 APPLICATION REPOSITORY
300 IaC REMOTE REPOSITORY
400 DEVELOPMENT TERMINAL
410 IaC LOCAL REPOSITORY
411 ENVIRONMENT CONSTRUCTION TOOL
41n ENVIRONMENT CONSTRUCTION TOOL
500 ENVIRONMENT CONSTRUCTION MANAGEMENT APPARATUS
510 STORAGE UNIT
511 PROGRAM
512 TEST HISTORY DB
520 MEMORY
530 COMMUNICATION UNIT
540 CONTROL UNIT
541 DETECTION UNIT
542 SPECIFYING UNIT
543 TESTING UNIT
544 REGISTRATION UNIT
5121 HISTORY INFORMATION
512m HISTORY INFORMATION
551 HISTORY ID
552 TEST TYPE
553 PROCESSING CONDITION INFORMATION OF ENVIRONMENTAL ELEMENT
5531 IaC
5532 ENVIRONMENT CONSTRUCTION TOOL
5533 OPERATING ENVIRONMENT
5534 OUTSIDE PACKAGE
600 TESTING ENVIRONMENT
610 INFORMATION SYSTEM
620 INFRASTRUCTURE CONFIGURATION
621 NETWORK ELEMENT
622 HARDWARE ELEMENT
623 OS
624 MIDDLEWARE
630 APPLICATION
700 OUTSIDE PACKAGE REPOSITORY
800 MONITORING APPARATUS
N NETWORK

What is claimed is:

1. An environment construction management apparatus comprising:
detection means for detecting a change in an environmental element that could affect an environment construction process of a predetermined information system;
specifying portion for specifying processing condition information corresponding to an environmental element in which a change is detected;
testing portion for performing a test for the environment construction process using the specified processing condition information for a testing environment for the information system; and
registration portion for registering, as history information, a result of the test and the specified processing condition information in association with each other.

2. The environment construction management apparatus according to claim 1, wherein the testing portion performs a test for the environment construction process by using an environment construction tool configured to operate based on an IaC (Infrastructure as code) created for constructing an environment for the information system.

3. The environment construction management apparatus according to claim 2, wherein the change in the environmental element includes an update of the IaC.

4. The environment construction management apparatus according to claim 2, wherein the change in the environmental element includes an update of the environment construction tool.

5. The environment construction management apparatus according to claim 2, wherein the change in the environmental element includes an update of configuration information of an operating environment for the information system.

6. The environment construction management apparatus according to claim 2, wherein the change in the environmental element includes an update in regard to reference information which is referred to from at least one of the IaC, the environment construction tool, and the operating environment for the information system.

7. The environment construction management apparatus according to claim 1, wherein the detection portion detects the change from among a plurality of environmental elements.

8. The environment construction management apparatus according to claim 1, wherein
the detection portion receives a notification including a type of the environmental element and the processing condition information corresponding to the environmental element from outside, and thereby detects a change in the environmental element included in the notification, and
the specifying portion specifies the processing condition information included in the notification.

9. An environment construction management system comprising:
a storage device; and
an information processing apparatus connected to the storage device, wherein
the information processing apparatus comprises:
detection portion for detecting a change in an environmental element that could affect an environment construction process of a predetermined information system;
specifying portion for specifying processing condition information corresponding to an environmental element in which a change is detected;
testing portion for performing a test for the environment construction process using the specified processing condition information for a testing environment for the information system; and
registration portion for registering, as history information, a result of the test and the specified processing condition information in association with each other in the storage device.

10. The environment construction management system according to claim 9, wherein the testing portion performs a test for the environment construction process by using an environment construction tool configured to operate based on an IaC (Infrastructure as code) created for constructing an environment for the information system.

11. The environment construction management system according to claim 10, wherein the change in the environmental element includes an update of the IaC.

12. The environment construction management system according to claim 10, wherein the change in the environmental element includes an update of the environment construction tool.

13. The environment construction management system according to claim 10, wherein the change in the environmental element includes an update of configuration information of an operating environment for the information system.

14. The environment construction management system according to claim 10, wherein the change in the environmental element includes an update in regard to reference information which is referred to from at least one of the IaC, the environment construction tool, and the operating environment for the information system.

15. The environment construction management system according to claim 9, wherein the detection portion detects the change from among a plurality of environmental elements.

16. The environment construction management system according to claim 9, further comprising notification portion for transmitting, in response to an update in regard to the environmental element, a notification including a type of the environmental element and the processing condition information corresponding to the environmental element to an information processing apparatus, wherein
the detection portion receives the notification from the notification portion, and thereby detects a change in the environmental element included in the notification, and
the specifying portion specifies the processing condition information included in the notification.

17. An environment construction management method, wherein a computer:
detects a change in an environmental element that could affect an environment construction process of a predetermined information system;
specifies processing condition information corresponding to an environmental element in which a change is detected;
performs a test for the environment construction process using the specified processing condition information for a testing environment for the information system; and
registers, as history information, a result of the test and the specified processing condition information in association with each other in a storage device.

18. The environment construction management method according to claim 17, wherein the testing portion performs a test for the environment construction process by using an environment construction tool configured to operate based on an IaC (Infrastructure as code) created for constructing an environment for the information system.

19. The environment construction management method according to claim 18, wherein the change in the environmental element includes an update of the IaC.

20. (canceled)
